(19) United States
(12) Patent Application Publication
(10) Pub. No.: US 2024/0039977 A1
(43) Pub. Date: Feb. 1, 2024

(54) SIGNAL PROCESSING DEVICE AND LEARNING DEVICE

(71) Applicant: SONY GROUP CORPORATION, TOKYO (JP)

(72) Inventors: RYUJI TOKUNAGA, TOKYO (JP); AKIO TANAKA, TOKYO (JP); TAKAFUMI HATTORI, TOKYO (JP); YASUHIRO TOGURI, TOKYO (JP); CHISATO KEMMOCHI, TOKYO (JP)

(21) Appl. No.: 18/257,575

(22) PCT Filed: Dec. 8, 2021
(86) PCT No.: PCT/JP2021/045033

§ 371 Date: Jun. 14, 2023

(30) Foreign Application Priority Data
Dec. 22, 2020 (JP) 2020-212056

(51) Int. Cl. H04L 65/80; H04L 65/70; H04B 17/318

(52) U.S. Cl. CPC H04L 65/80; H04L 65/70; H04B 17/318

(57) ABSTRACT

The present technique relates to a signal processing device and a learning device capable of improving playback quality. The signal processing device generates a packet by packetizing encoded data encoded in monaural and separated for channels; transmits, by wireless communication, the packet generated; and controls a number of retransmissions of the packet and a bitrate in accordance with a fluctuation value of a first parameter for estimating a radio wave state, the first parameter being obtained from a receiving device. The present technique can be applied in an audio playback system that plays back audio data.

### TECHNICAL FIELD

The present technique relates to a signal processing device and a learning device, and particularly relates to a signal processing device and a learning device capable of improving playback quality.

### BACKGROUND ART

Currently, wireless communication systems using Bluetooth (registered trademark) are widely used (see PTL 1). Bluetooth includes Bluetooth Classic, as well as BLE (Bluetooth Low Energy), which is a newer standard than Bluetooth Classic. There is also Classic audio, which is a Bluetooth Classic audio standard, and BLE audio, which is a BLE audio standard.

The isochronous type of transmission used in BLE audio (called “isochronous transmission” hereinafter) is bandwidth-guaranteed and enables transmission at regular intervals. In BLE audio, packet loss due to radio interference and the like can be compensated for by a retransmission function provided by the standard.

### CITATION LIST

### Patent Literature

[PTL 1]

JP 2018-42241A

### SUMMARY

### Technical Problem

However, in BLE audio, packet transmission is performed at regular intervals (at fixed times), and thus while a packet can be retransmitted up to the timing at which the next packet is transmitted, the number of retransmissions is limited.

On the other hand, in conventional Classic audio, the number of retransmissions can be set to any number. This means that the isochronous transmission in BLE audio is more susceptible to packet loss than conventional Classic audio.

In addition, in BLE audio, if the number of retransmissions is kept consistently high to avoid the increased chance of packet loss, the data size of the audio packets must be reduced, which inevitably affects the sound quality.

Having been achieved in light of such circumstances, the present technique makes it possible to improve playback quality.

### Solution to Problem

A signal processing device according to a first aspect of the present technique includes: a packet generation unit that generates a packet by packetizing encoded data encoded in monaural and separated for channels; a transmitting unit that transmits, by wireless communication, the packet generated; and a control unit that controls a number of retransmissions of the packet and a bitrate in accordance with a fluctuation value of a first parameter for estimating a radio wave state, the first parameter being obtained from a receiving device.

A learning device according to a second aspect of the present technique includes: a learning unit that learns packet loss occurrence prediction by taking, as inputs, a first parameter that is a parameter for estimating a radio wave state for transmitting, through wireless communication, a packet generated by packetizing encoded data encoded in monaural and separated for channels, and is a parameter obtained from a receiving device of the packet, a number of retransmissions of the packet, and a second parameter that is a parameter transmitted from the receiving device and is different from the first parameter; and a setting unit that sets a new number of retransmissions of the packet in accordance with the occurrence prediction.

A learning device according to a third aspect of the present technique includes: a learning unit that, by taking a first parameter that is a parameter for estimating a radio wave state for transmitting, through wireless communication, a packet generated by packetizing encoded data encoded in monaural and separated for channels, and is a parameter obtained from a receiving device of the packet, a number of retransmissions of the packet, and a second parameter that is a parameter transmitted from the receiving device and is different from the first parameter as inputs, learns a new number of retransmissions of the packet. A signal processing device according to a fourth aspect of the present technique includes: a receiving unit that, based on a number of retransmissions of a packet and a bitrate controlled in accordance with a fluctuation value of a first parameter obtained through transmission with the signal processing device itself and being used to estimate a radio wave state, receives the packet, the packet being encoded in monaural and separated for channels and transmitted from a transmitting device; and a decoding unit that decodes the packet.

In the first aspect of the present technique, a packet is generated by packetizing encoded data encoded in monaural and separated for channels; the packet generated is transmitted by wireless communication; and a number of retransmissions of the packet and a bitrate are controlled in accordance with a fluctuation value of a first parameter for estimating a radio wave state, the first parameter being obtained from a receiving device.

In the second aspect of the present technique, packet loss occurrence prediction is learned by taking, as inputs, a first parameter that is a parameter for estimating a radio wave state for transmitting, through wireless communication, a packet generated by packetizing encoded data encoded in monaural and separated for channels, and is a parameter obtained from a receiving device of the packet, a number of retransmissions of the packet, and a second parameter that is a parameter transmitted from the receiving device and is different from the first parameter; and a new number of retransmissions of the packet is set in accordance with the occurrence prediction.

In the third aspect of the present technique, by taking a first parameter that is a parameter for estimating a radio wave state for transmitting, through wireless communication, a packet generated by packetizing encoded data encoded in monaural and separated for channels, and is a parameter obtained from a receiving device of the packet, a number of retransmissions of the packet, and a second parameter that is a parameter transmitted from the receiving device and is different from the first parameter as inputs, a new number of retransmissions of the packet is learned.

In the fourth aspect of the present technique, based on a number of retransmissions of a packet and a bitrate controlled in accordance with a fluctuation value of a first parameter obtained through transmission with the signal processing device itself and being used to estimate a radio wave state, the packet is received, the packet being encoded in monaural and separated for channels and transmitted from a transmitting device; and the packet is decoded.

### BRIEF DESCRIPTION OF DRAWINGS

FIG. 1 is a block diagram illustrating an example of the configuration of Embodiment 1 of an audio playback system to which the present technique is applied.

FIG. 2 is a diagram illustrating a first example of isochronous transmission.

FIG. 3 is a diagram illustrating a second example of isochronous transmission.

FIG. 4 is a diagram illustrating a third example of isochronous transmission.

FIG. 5 is a flowchart illustrating processing by an audio server illustrated in FIG. 1.

FIG. 6 is a flowchart illustrating retransmission number setting processing in step S12 of FIG. 5.

FIG. 7 is a block diagram illustrating an example of the configuration of Embodiment 2 of an audio playback system to which the present technique is applied.

FIG. 8 is a flowchart illustrating processing by an audio server illustrated in FIG. 7.

FIG. 9 is a diagram illustrating an example of the configuration of a packet loss occurrence learning device.

FIG. 10 is a diagram illustrating an example of the configuration of a playback number learning device.

FIG. 11 is a block diagram illustrating an example of the configuration of Embodiment 3 of an audio playback system to which the present technique is applied.

FIG. 12 is a block diagram illustrating an example of the configuration of a computer.

### DESCRIPTION OF EMBODIMENTS

Embodiments for carrying out the present technique will be described hereinafter. The descriptions will be given in the following order.
1. Embodiment 1 (Dual-Channel Configuration)
2. Embodiment 2 (Configuration Using TX Power)
3. Embodiment 3 (Multichannel Configuration)
4. Other

### 1. Embodiment 1 (Dual-Channel Configuration)

<Configuration of Audio Playback System>

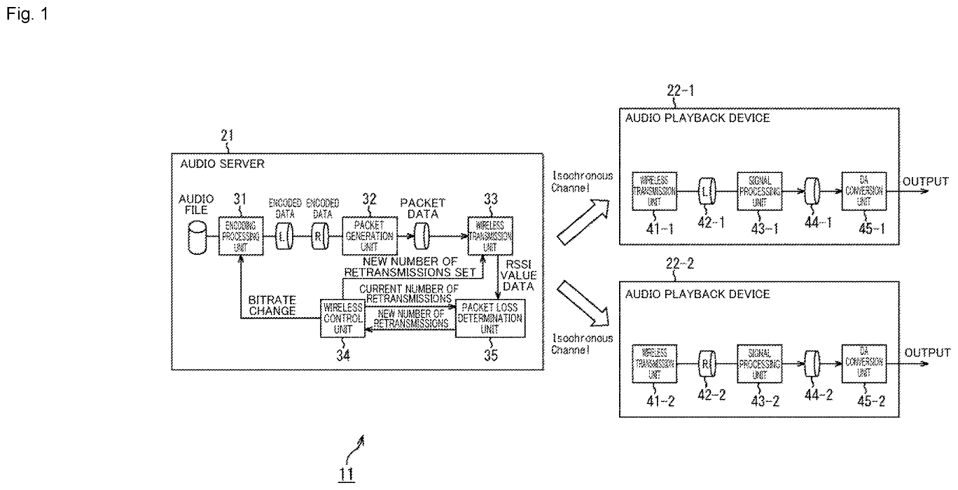

FIG. 1 is a block diagram illustrating an example of the configuration of Embodiment 1 of an audio playback system to which the present technique is applied.

An audio playback system 11 illustrated in FIG. 1 is a system that plays back dual-channel audio data.

The audio playback system 11 is constituted by an audio server 21, an audio playback device 22-1 that plays back Lch audio data, and an audio playback device 22-2 that plays back Rch audio data.

The audio server 21 is constituted by, for example, a smartphone, a tablet terminal, a dedicated playback terminal, or the like. The audio playback device 22-1 and the audio playback device 22-2 are constituted by, for example, wireless earphones. When there is no particular need to distinguish between the audio playback device 22-1 and the audio playback device 22-2, those devices will be collectively referred to as an “audio playback device 22”.

The audio server 21 and the audio playback device 22 enter a state in which data can be transmitted after undergoing a synchronization procedure defined in wireless transmission. Additionally, the audio server 21 and the audio playback device 22 ensure the timing and bandwidth for data transmission by using isochronous transmission.

Note that connection-type isochronous transmission is used in the audio playback system 11. In connection-type isochronous transmission, a receiving device transmits an ACK to a transmitting device when a packet has been successfully received, and transmits a NACK to the transmitting device when a packet has failed to be received.

The audio server 21 is constituted by an encoding processing unit 31, a packet generation unit 32, a wireless transmission unit 33, a wireless control unit 34, and a packet loss determination unit 35.

The encoding processing unit 31 separates a stereo audio file (PCM data) into individual channels, encodes each channel in monoaural, and generates two channels of encoded data separated into the individual channels (Lch encoded data and Rch encoded data).

The packet generation unit 32 adds header data to the Lch encoded data and the Rch encoded data, and generates one packet for each. The header data is data including, for example, identification information such as a destination ID, a sequence number, and the like.

The wireless transmission unit 33 transmits the Lch packet generated by the packet generation unit 32 to the audio playback device 22-1. The wireless transmission unit 33 transmits the Rch packet generated by the packet generation unit 32 to the audio playback device 22-2. The wireless transmission unit 33 obtains Received Signal Strength Indicator (RSSI) values (a first parameter) through transmission with the audio playback devices 22-1 and 22-2, respectively, and outputs those values to the packet loss determination unit 35. Here, the Received Signal Strength Indicator (RSSI) value expresses the extent to which the audio playback device 22 can receive a signal transmitted from the audio server 21.

The wireless control unit 34 changes a number of retransmissions by the wireless transmission unit 33 using a number of retransmissions supplied from the packet loss determination unit 35, and requests the encoding processing unit 31 to change a bitrate in accordance with a result of comparing a new number of retransmissions with a past number of retransmissions. The wireless control unit 34 requests the encoding processing unit 31 to reduce the bitrate when the new number of retransmissions is greater than the past number of retransmissions. The wireless control unit 34 requests the encoding processing unit 31 to increase the bitrate when the new number of retransmissions is less than the past number of retransmissions.

The packet loss determination unit 35 obtains the RSSI values of the audio playback devices 22-1 and 22-2 from the wireless transmission unit 33, and obtains a current number of retransmissions from the wireless control unit 34.

The RSSI value takes a constant value when the radio wave state is stable. However, the RSSI value fluctuates greatly when the radio wave state deteriorates due to radio interference.

The packet loss determination unit 35 determines whether the radio wave state is good or poor by monitoring fluctuations in the RSSI value. The packet loss determination unit 35 sets the number of retransmissions of the packet in accordance with fluctuations in the RSSI value.

Specifically, the packet loss determination unit 35 updates an RSSI value table, which is a table of past RSSI values, with new RSSI values that are obtained. In other words, the packet loss determination unit 35 replaces the oldest RSSI value in a past RSSI value table with a new RSSI value.

The packet loss determination unit 35 uses the post-replacement RSSI value table to obtain a variance value of the RSSI value and a slope after performing linear approximation (called a “linear approximation slope” hereinafter).

The packet loss determination unit 35 also holds the variance value of the RSSI value and the linear approximation slope at the time of packet loss as reference data.

The packet loss determination unit 35 compares the variance value of the RSSI value and the linear approximation slope that have been obtained with the reference data at the time of packet loss, and sets the number of retransmissions based on a result of the comparison.

In other words, when both the variance value of the RSSI value and the linear approximation slope are in an increasing trend, the packet loss determination unit 35 increases the number of retransmissions under the assumption that there is an increased risk of packet loss.

Similarly, when one of the variance value of the RSSI value and the linear approximation slope is in an increasing trend, the packet loss determination unit 35 increases the number of retransmissions under the assumption that there is an increased risk of packet loss. However, the number of the increase when only one is in an increasing trend can be kept lower than the number of the increase when both are in an increasing trend.

When both the variance value of the RSSI value and the linear approximation slope are in a decreasing trend, the packet loss determination unit 35 reduced the number of retransmissions under the assumption that there is a reduced risk of packet loss.

When both the variance value of the RSSI value and the linear approximation slope are in a steady state, with neither an increase nor a decrease, the packet loss determination unit 35 does not change the number of retransmissions, under the assumption that the communication state is stable.

The packet loss determination unit 35 outputs the set number of retransmissions to the wireless control unit 34.

The audio playback device 22-1 is constituted by a wireless transmission unit 41-1, a packet buffer 42-1, a signal processing unit 43-1, a PCM buffer 44-1, and a Digital to Analog (DA) conversion unit 45-1. The audio playback device 22-2 is constituted by a wireless transmission unit 41-2, a packet buffer 42-2, a signal processing unit 43-2, a PCM buffer 44-2, and a DA conversion unit 45-2.

When there is no particular need to distinguish between the wireless transmission units 41-1 and 41-2, the packet buffers 42-1 and 42-2, and the signal processing units 43-1 and 43-2, those units will be referred to simply as a “wireless transmission unit 41”, a “packet buffer 42”, and a “signal processing unit 43”, respectively. When there is no particular need to distinguish between the PCM buffers 44-1 and 44-2 and the DA conversion units 45-1 and 45-2, those units will be referred to simply as a “PCM buffer 44” and a “DA conversion unit 45”, respectively. An example of receiving an L packet will be described hereinafter.

The wireless transmission unit 41 receives an Lch packet transmitted from the audio server 21. The wireless transmission unit 41 outputs the received Lch packet to the packet buffer 42.

When the Lch packet has been received correctly, the wireless transmission unit 41 transmits an ACK to the audio server 21. When the Lch packet has not been received correctly due to bit loss or the like, the wireless transmission unit 41 transmits a NACK to the audio server 21.

The packet buffer 42 buffers Lch packets.

The signal processing unit 43 retrieves and decodes the Lch packets from the packet buffer 42 and buffers the decoded PCM data in the PCM buffer 44.

The DA conversion unit 45 converts the digital PCM data buffered in the PCM buffer 44 into analog and outputs analog audio data.

<Isochronous Transmission>

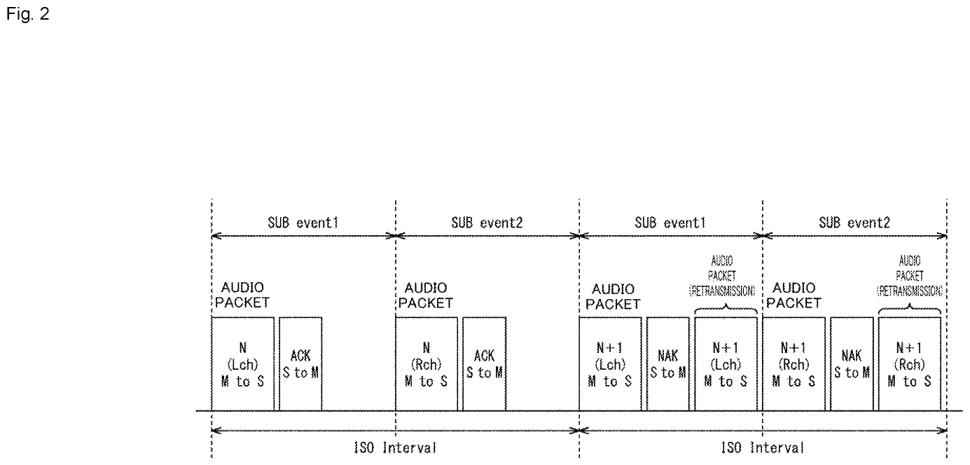

An example of isochronous transmission will be described next with reference to FIGS. 2 to 4.

FIG. 2 is a diagram illustrating a first example of isochronous transmission.

FIG. 2 illustrates an example in which a packet (Nth) is transmitted at a first ISO interval and a packet (N+1th) is transmitted at the next ISO interval. In addition, FIG. 2 illustrates an example in which an audio packet can be retransmitted only once. Note that in the drawing, “M to S” indicates that the packet is a packet transmitted from a master to a slave, whereas “S to M” indicates that the packet is a packet transmitted from a slave to a master. Here, the audio server 21 corresponds to the master, and the audio playback device 22 corresponds to the slave.

In the first ISO interval, the audio server 21 transmits the Lch packet (Nth) to the audio playback device 22-1 at SUB event1. If the Lch packet (Nth) is received correctly by the audio playback device 22-1, an ACK is transmitted from the audio playback device 22-1 to the audio server 21.

Then, in the time up to the following SUB event2, the audio server 21 can transition to a sleep state. The audio server 21 can therefore reduce power consumption.

Similarly, the audio server 21 transmits the Rch packet (Nth) to the audio playback device 22-2 at SUB event2. If the Rch packet (Nth) is received correctly by the audio playback device 22-2, an ACK is transmitted from the audio playback device 22-2 to the audio server 21.

Then, in the time up to the following SUB event1, the audio server 21 can transition to a sleep state. The audio server 21 can therefore reduce power consumption.

In the next ISO interval, the audio server 21 transmits the Lch packet (N+1th) to the audio playback device 22-1 at SUB event1. If the Lch packet (N+1th) is not received correctly by the audio playback device 22-1, a NACK is transmitted from the audio playback device 22-1 to the audio server 21. Then, the audio server 21 retransmits the Lch packet (N+1th) to the audio playback device 22-1.

The audio server 21 transmits the Rch packet (N+1th) to the audio playback device 22-2 at SUB event2. If the Rch packet (N+1th) is not received correctly by the audio playback device 22-2, a NACK is transmitted from the audio playback device 22-2 to the audio server 21. Then, the audio server 21 retransmits the Rch packet (N+1th) to the audio playback device 22-2.

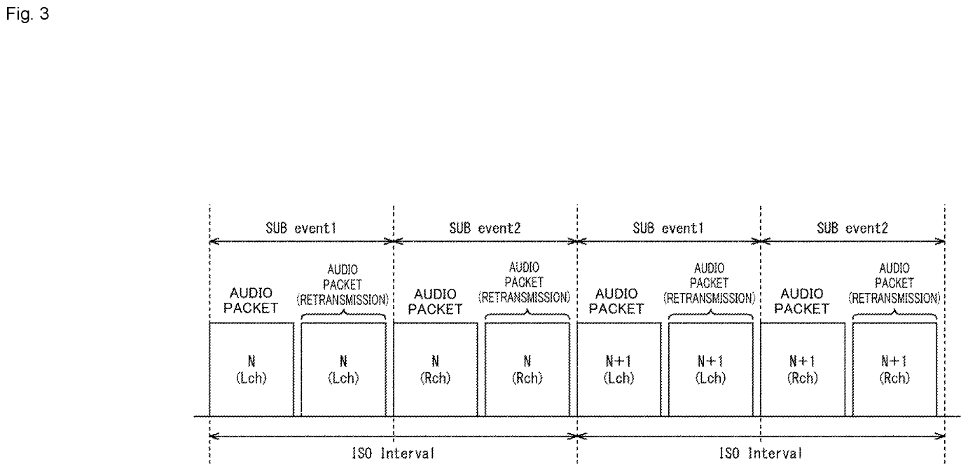

FIG. 3 is a diagram illustrating a second example of isochronous transmission.

Similar to FIG. 2, FIG. 3 illustrates an example in which a packet (Nth) is transmitted at a first ISO interval and a packet (N+1th) is transmitted at the next ISO interval. Also similar to FIG. 2, FIG. 3 illustrates an example in which an audio packet can be retransmitted only once.

Note that the transmission of ACKs and NACKs is not shown in the example in FIG. 3.

In the first ISO interval, the audio server 21 transmits the Lch packet (Nth) to the audio playback device 22-1 at SUB event1. If a retransmission of the Lch packet (Nth) is required, the audio server 21 retransmits the Lch packet (Nth) to the audio playback device 22-1.

The audio server 21 transmits the Rch packet (Nth) to the audio playback device 22-2 at SUB event2. If a retransmission of the Rch packet (Nth) is required, the audio server 21 retransmits the Rch packet (Nth) to the audio playback device 22-2.

In the next ISO interval, the audio server 21 transmits the Lch packet (N+1th) to the audio playback device 22-1 at SUB event1. If a retransmission of the Lch packet (N+1th) is required, the audio server 21 retransmits the Lch packet (N+1th) to the audio playback device 22-1.

The audio server 21 transmits the Rch packet (N+1th) to the audio playback device 22-2 at SUB event2. If a retransmission of the Rch packet (N+1th) is required, the audio server 21 retransmits the Rch packet (N+1th) to the audio playback device 22-2.

It is expected that when the number of retransmissions of audio data is limited to one, the audio data will be vulnerable to transmission errors, and when audio packets are retransmitted continuously, as in the example in FIG. 3, sound skips and the like are likely to occur.

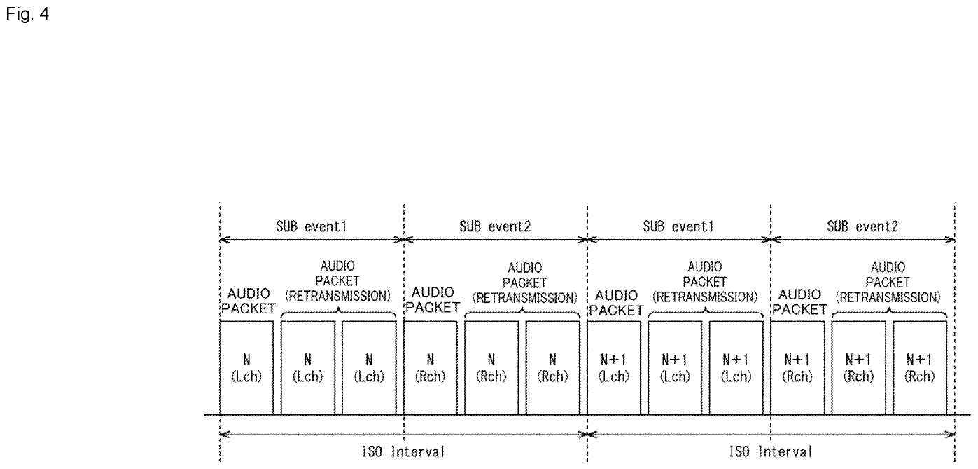

FIG. 4 is a diagram illustrating a third example of isochronous transmission. Compared to the examples in FIGS. 2 and 3, FIG. 4 illustrates an example in which up to two retransmissions can be performed for audio packets by reducing the size of the audio packets.

The transmission of ACKs and NACKs is not shown in the example in FIG. 4 as well.

In the first ISO interval, the audio server 21 transmits the Lch packet (Nth) to the audio playback device 22-1 at SUB event1. If a retransmission of the Lch packet (Nth) is required, the audio server 21 retransmits the Lch packet (Nth) to the audio playback device 22-1. Furthermore, if a retransmission of the Lch packet (Nth) is required, the audio server 21 retransmits the Lch packet (Nth) to the audio playback device 22-1.

The audio server 21 transmits the Rch packet (Nth) to the audio playback device 22-2 at SUB event2. If a retransmission of the Rch packet (Nth) is required, the audio server 21 retransmits the Rch packet (Nth) to the audio playback device 22-2. Furthermore, if a retransmission of the Rch packet (Nth) is required, the audio server 21 retransmits the Rch packet (Nth) to the audio playback device 22-2.

In the next ISO interval, the audio server 21 transmits the Lch packet (N+1th) to the audio playback device 22-1 at SUB event1. If a retransmission of the Lch packet (N+1th) is required, the audio server 21 retransmits the Lch packet (N+1th) to the audio playback device 22-1. Furthermore, if a retransmission of the Lch packet (N+1th) is required, the audio server 21 retransmits the Lch packet (N+1th) to the audio playback device 22-1.

The audio server 21 transmits the Rch packet (N+1th) to the audio playback device 22-2 at SUB event2. If a retransmission of the Rch packet (N+1th) is required, the audio server 21 retransmits the Rch packet (N+1th) to the audio playback device 22-2. Furthermore, if a retransmission of the Rch packet (N+1th) is required, the audio server 21 retransmits the Rch packet (N+1th) to the audio playback device 22-2.

In this manner, vulnerability to transmission errors can be improved by increasing the number of retransmissions of the audio data to two. However, the size of the audio packets is reduced, which is expected to reduce the sound quality. Accordingly, in the present technique, the packet loss determination unit 35 obtains an appropriate number of retransmissions in accordance with fluctuations in the RSSI value, i.e., the radio wave state, and the wireless control unit 34 sets the number of retransmissions and the bitrate. This makes it possible to achieve transmission quality providing better sound quality and less sound skipping.

<Audio Server Operations>

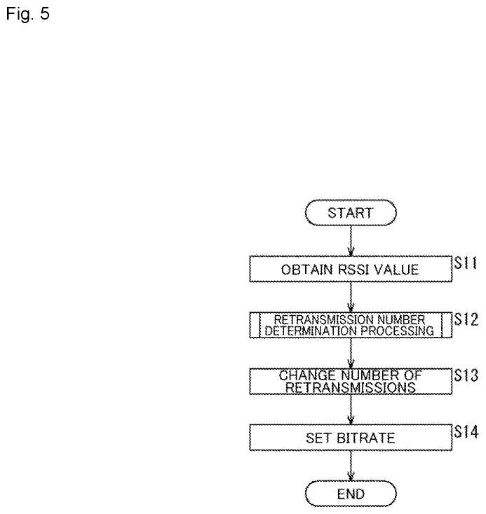

FIG. 5 is a flowchart illustrating processing by the audio server 21 illustrated in FIG. 1.

The processing in FIG. 5 is performed while a data link is being established. Note that the processing is not limited to being performed while a data link is being established, and may be performed, for example, at each of predetermined timings.

In step S11, the wireless transmission unit 33 obtains the Received Signal Strength Indicator (RSSI) values (the first parameter) through transmission with the audio playback devices 22-1 and 22-2, respectively, and outputs those values to the packet loss determination unit 35. The packet loss determination unit 35 obtains the RSSI values of the audio playback devices 22-1 and 22-2 from the wireless transmission unit 33.

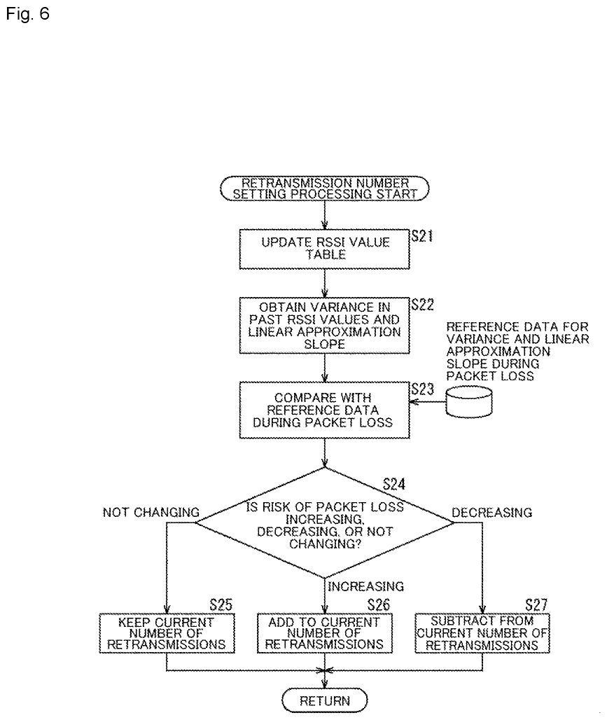

In step S12, the packet loss determination unit 35 performs retransmission number setting processing. The retransmission number setting processing will be described in detail later with reference to FIG. 6. A new number of retransmissions is set through the processing of step S12. The packet loss determination unit 35 outputs the new number of retransmissions to the wireless control unit 34.

In step S13, the wireless control unit 34 changes the number of retransmissions of the wireless transmission unit 33 using the new number of retransmissions.

In step S14, the wireless control unit 34 requests the encoding processing unit 31 to change the bitrate in accordance with the result of comparing the new number of retransmissions with the past number of retransmissions. The encoding processing unit 31 sets the bitrate to the bitrate requested to be changed to by the wireless control unit 34.

After step S14, the processing by the audio server 21 ends.

FIG. 6 is a flowchart illustrating the retransmission number setting processing in step S12 of FIG. 5.

In step S21, the packet loss determination unit 35 updates the RSSI value table, which is a table of past RSSI values, with new RSSI values that are obtained. In other words, the packet loss determination unit 35 replaces the oldest RSSI value in a past RSSI value table with a new RSSI value.

In step S22, the packet loss determination unit 35 uses the post-replacement RSSI value table to obtain the variance value of the RSSI value and the linear approximation slope.

In step S23, the packet loss determination unit 35 compares the variance value of the RSSI value and the linear approximation slope that have been obtained with the reference data at the time of packet loss.

In step S24, the packet loss determination unit 35 determines whether the risk of packet loss occurring has increased, decreased, or is unchanged based on the result of the comparison. If it is determined in step S24 that the risk of packet loss occurring is unchanged, the processing moves to step S25.

In step S25, the packet loss determination unit 35 keeps the current number of retransmissions, without changing the number of retransmissions. The packet loss determination unit 35 outputs the number of retransmissions as-is to the wireless control unit 34.

If it is determined in step S24 that the risk of packet loss occurring is increasing, the processing moves to step S26.

In step S26, the packet loss determination unit 35 adds to the number of retransmissions. The packet loss determination unit 35 outputs the number of retransmissions added to as the new number of retransmissions to the wireless control unit 34.

If it is determined in step S24 that the risk of packet loss occurring is decreasing, the processing moves to step S27.

In step S27, the packet loss determination unit 35 subtracts from the number of retransmissions. The packet loss determination unit 35 outputs the number of retransmissions subtracted from as the new number of retransmissions to the wireless control unit 34.

After steps S25 to S27, the retransmission number setting processing ends.

As described above, in the present technique, an optimal number of retransmissions and bitrate are set in accordance with the radio wave state. Accordingly, the audio server 21 does not need to pause transmission in order to set an optimal number of retransmissions, bitrate, or the like. This makes it possible to improve the sound quality when the radio wave state is good. Meanwhile, when the radio wave state is deteriorating, the stability of packet transmission can be improved.

### 2. Embodiment 2 (Configuration Using TX Power)

<Configuration of Audio Playback System>

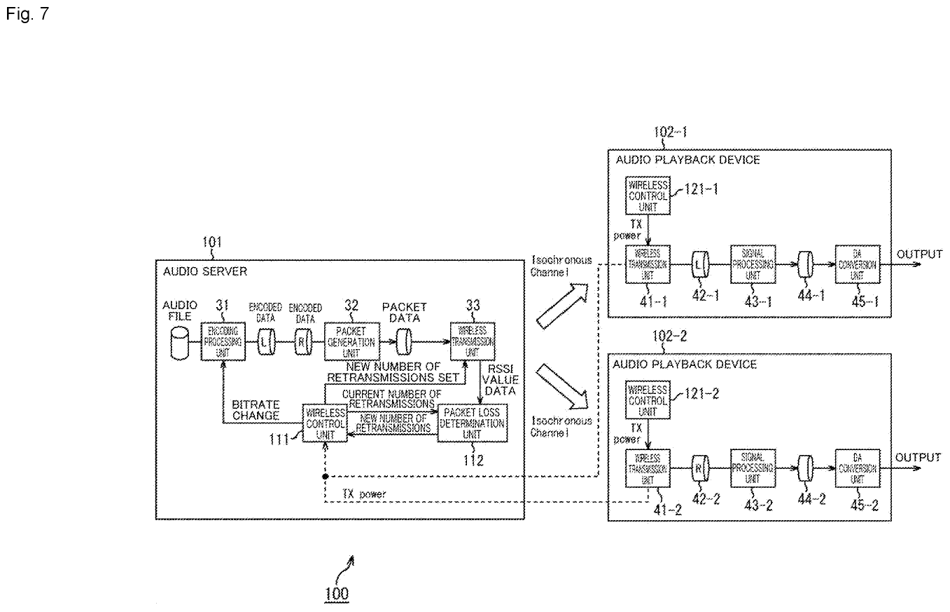

FIG. 7 is a block diagram illustrating an example of the configuration of Embodiment 2 of an audio playback system to which the present technique is applied.

An audio playback system 100 illustrated in FIG. 7 is constituted by an audio server 101, an audio playback device 102-1, and an audio playback device 102-2. When there is no particular need to distinguish between the audio playback device 102-1 and the audio playback device 102-2, those devices will be collectively referred to as an “audio playback device 102”.

The audio server 101 differs from the audio server 21 illustrated in FIG. 1 in that the wireless control unit 34 has been replaced with a wireless control unit 111, and the packet loss determination unit 35 has been replaced by a packet loss determination unit 112.

In other words, the wireless control unit 111 receives TX power (a second parameter) from the audio playback device 102. TX power indicates a transmission power measured at a distance of 1 m. The transmission and reception of the TX power may use a transmission path from the audio playback device 102 to the audio server 101 during isochronous transmission, or may use another communication link.

The RSSI and the TX power are, according to the Friis transmission formula, inversely proportional to the square of the distance between the transmitting device and the receiving device, and an approximate distance can therefore be known from the RSSI and TX power. The distance d is expressed by the following Formula (1).

[Math. 1]

RSSI=10*log(λ/4πd)\hat{ }2+TX Power d=(λ/4π)*10\hat{ }((TX Power−RSSI)/20) (1)

Here, λ represents a wavelength and d represents a distance.

The packet loss determination unit 112 obtains the TX power from the wireless control unit 111, and sets an initial value for the appropriate number of retransmissions using the RSSI and the TX power.

There is a higher incidence of packet loss when the distance between the transmitting device and the receiving device is great, and thus the packet loss determination unit 112 can set the initial value for the appropriate number of retransmissions according to the distance.

The audio playback device 102 differs from the audio playback device 22 illustrated in FIG. 1 in that a wireless control unit 121 has been added.

In other words, the wireless control unit 121 controls the wireless transmission unit 41 and causes the TX power to be transmitted to the audio server 21.

<Audio Server Operations>

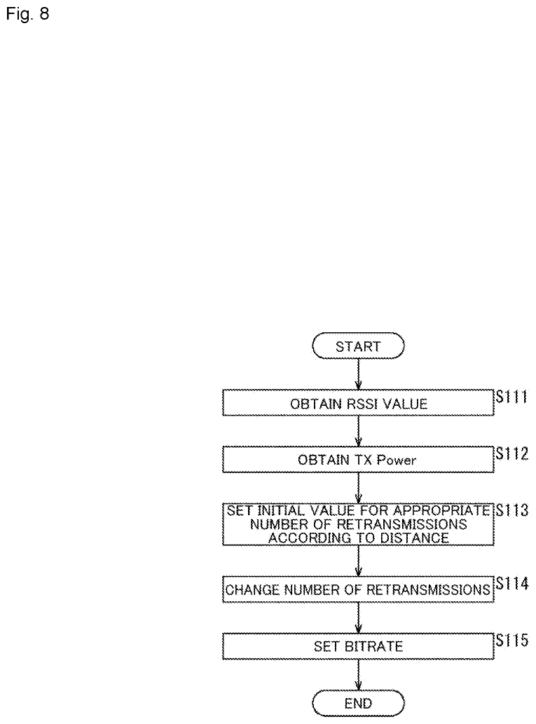

FIG. 8 is a flowchart illustrating processing by the audio server 101 illustrated in FIG. 7.

In step S111, the wireless transmission unit 33 obtains the RSSI values through transmission with the audio playback devices 22-1 and 22-2, respectively, and outputs those values to the packet loss determination unit 112. The packet loss determination unit 112 obtains the RSSI values of the audio playback devices 102-1 and 102-2 from the wireless transmission unit 33.

The wireless transmission unit 41 of the audio playback device 102 transmits the TX power to the audio server 101.

In step S112, the wireless control unit 111 receives the TX power from the audio playback device 102. The packet loss determination unit 112 obtains the TX power from the wireless control unit 111.

In step S113, the packet loss determination unit 112 determines the distance between the audio server 101 and each of the audio playback devices 102 based on the RSSI values and the TX power. The packet loss determination unit 112 sets the initial value of the appropriate number of retransmissions according to the distance obtained. The packet loss determination unit 112 outputs the set initial value for the number of retransmissions as the new number of retransmissions to the wireless control unit 111.

In step S114, the wireless control unit 111 changes the number of retransmissions of the wireless transmission unit 33 using the new number of retransmissions.

In step S115, the wireless control unit 111 requests the encoding processing unit 31 to change the bitrate in accordance with the result of comparing the new number of retransmissions with the past number of retransmissions. The encoding processing unit 31 sets the bitrate to the bitrate requested to be changed to by the wireless control unit 111.

After step S115, the processing by the audio server 101 ends.

Note that when there is one transmitting device and a plurality of receiving devices, when the distances between the transmitting device and each of the plurality of receiving devices are different, an appropriate number of retransmissions for the receiving device at the farthest distance may be taken as the initial value.

Additionally, although it is assumed, for example, that moving the receiving device during audio playback will change the distance between the transmitting device and the receiving device, the present technique makes it possible to reset the appropriate number of retransmissions according to the distance in such a case as well. However, the basis for this setting is not limited thereto. For example, when there are three receiving devices, the setting may be based on the device that is closest to the transmitting device, an intermediate device, or the like, or may be based on an average value of the distances between the transmitting device and each of the plurality of receiving devices (including cases where each of the plurality of receiving devices moves).

<Example of Configuration of Packet Loss Occurrence Learning Device>

The packet loss determination unit 112 illustrated in FIG. 7 and described above can also be configured to include a learning engine that, through machine learning, has learned optimal packet loss occurrence prediction, the number of retransmissions, and the like.

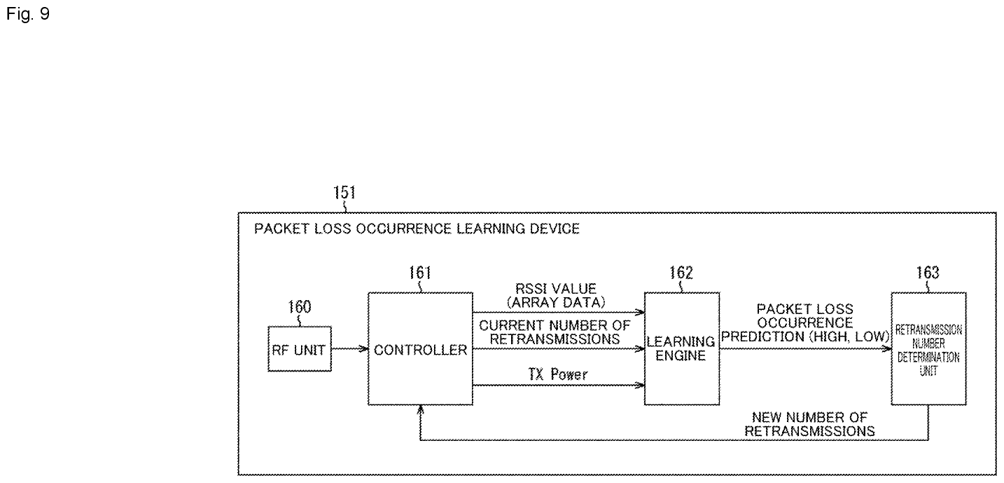

FIG. 9 is a block diagram illustrating an example of the configuration of a packet loss occurrence learning device 151 that learns optimal packet loss occurrence prediction.

The packet loss occurrence learning device 151 illustrated in FIG. 9 outputs an optimal packet loss occurrence prediction through machine learning.

The packet loss occurrence learning device 151 is constituted by an RF unit 160, a controller 161, a learning engine 162, and a retransmission number determination unit 163.

The RF unit 160 corresponds to the wireless transmission unit 33. The RF unit 160 demodulates radio waves received by an antenna (not shown) and outputs a baseband signal to the controller 161.

The controller 161 corresponds to the wireless control unit 111. The controller 161 obtains the RSSI values and the TX power from the baseband signal supplied from the RF unit 160 and outputs those items to the learning engine 162. The controller 161 also outputs a new number of retransmissions supplied from the retransmission number determination unit 163 to the learning engine 162 as the current number of retransmissions.

The learning engine 162 performs learning using the RSSI values, the current number of retransmissions, and the TX power as inputs, and outputs a packet loss occurrence prediction (high/low) to the retransmission number determination unit 163.

The retransmission number determination unit 163 sets the new number of retransmissions in accordance with the packet loss occurrence prediction, and outputs the set new number of retransmissions to the controller 161.

In this manner, in the learning engine 162, the packet loss occurrence prediction is learned through machine learning.

By including the learning engine 162, which has learned packet loss occurrence prediction in this manner, in the packet loss determination unit 112 illustrated in FIG. 7, the packet loss determination unit 112 illustrated in FIG. 7 can set, as the number of retransmissions for the next transmission, the new number of retransmissions based on the packet loss occurrence prediction by the learning engine 162.

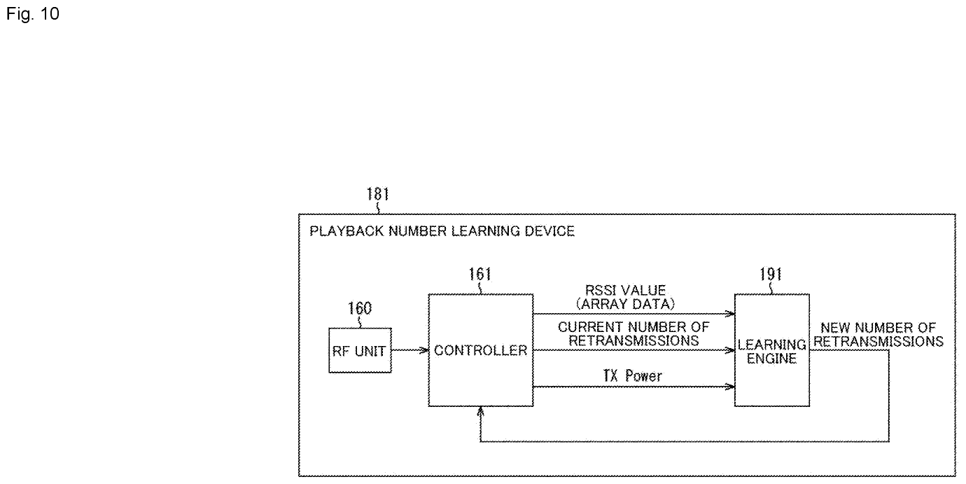

FIG. 10 is a block diagram illustrating another example of the configuration of a retransmission number learning device 181 that learns an optimal number of retransmissions.

Note that in FIG. 10, parts corresponding to those in FIG. 9 are indicated by corresponding reference signs, and only different parts will be described in detail.

The retransmission number learning device 181 illustrated in FIG. 10 outputs an optimal number of retransmissions through machine learning.

The retransmission number learning device 181 is constituted by the RF unit 160, the controller 161, and a learning engine 191.

The learning engine 191 performs learning using the RSSI values, the current number of retransmissions, and the TX power as inputs, and outputs a new number of retransmissions to the controller 161.

In this manner, in the learning engine 191, the number of playbacks is learned through machine learning.

By including the learning engine 191, which has learned the number of playbacks in this manner, in the packet loss determination unit 112 illustrated in FIG. 7, the packet loss determination unit 112 illustrated in FIG. 7 can set, as the number of retransmissions for the next transmission, the new number of retransmissions from the learning engine 191.

Note that the learning device may be installed in the audio server as a learning unit and perform learning while transmission processing is actually being performed.

### 3. Embodiment 3 (Multichannel Configuration)

<Configuration of Audio Playback System>

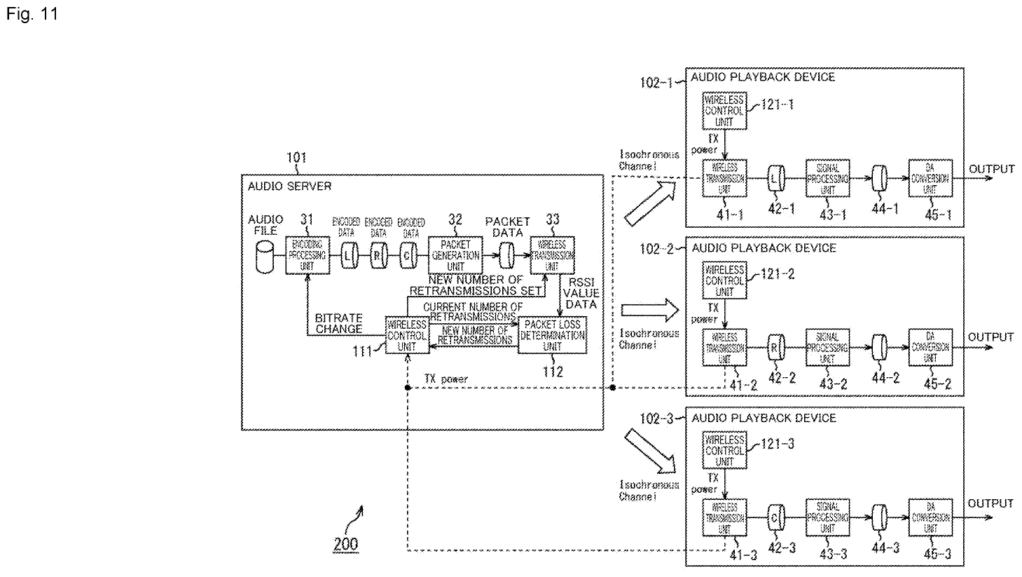

FIG. 11 is a block diagram illustrating an example of the configuration of Embodiment 3 of an audio playback system to which the present technique is applied.

An audio playback system 200 illustrated in FIG. 11 is a system that plays back multichannel audio data.

The audio playback system 200 illustrated in FIG. 11 is a system that plays back multichannel audio data. FIG. 11 illustrates an example of three channels. Note that in FIG. 11, parts corresponding to those in FIG. 7 are indicated by corresponding reference signs, and only different parts will be described in detail.

The audio playback system 200 is constituted by the audio server 101, the audio playback device 102-1 that plays back Lch audio data, the audio playback device 102-2 that plays back Rch audio data, and an audio playback device 102-3 that plays back Center channel (“Cch” hereinafter) audio data. When there is no particular need to distinguish among the audio playback device 102-1 to the audio playback device 102-3, those devices will be collectively referred to as an “audio playback device 102”.

The audio server 101 and the audio playback devices 102 are in a state in which data can be transmitted after undergoing a synchronization procedure defined in wireless transmission.

In other words, the audio playback system 200 is configured such that the audio playback device 102-3 has substantially been added to the audio playback system 100 illustrated in FIG. 7.

The audio server 101 illustrated in FIG. 11 is different from the audio server 101 illustrated in FIG. 7 in that in addition to the Lch audio data and the Rch audio data, the Cch audio data has been added as data realized as packets.

The audio playback device 102-3 differs from the audio playback devices 102-1 and 102-2 in that the received packets are Cch packets.

Similar to the audio playback system 11 illustrated in FIG. 1, connection-type isochronous transmission can be used in the audio playback system 200 illustrated in FIG. 11, but broadcast-type isochronous transmission can also be used.

In broadcast-type isochronous transmission, no ACKs or NACKs are transmitted from the receiving device, and it is therefore more important to set an optimal number of retransmissions than in the case of a connection-type transmission. Accordingly, although effective in connection-type isochronous transmission, the present technique is more effective in broadcast-type isochronous transmission than in connection-type transmission.

### 4. Other

<Effects>

As described thus far, in the present technique, data encoded in monaural and separated for channels is packetized to generate packets, and the generated packets are transmitted through wireless communication. The number of retransmissions of the packet and the bitrate are then controlled in accordance with a fluctuation value of a first parameter for estimating a radio wave state, obtained from a receiving device.

As a result, for example, the sound quality is improved when the radio wave state is good, whereas the stability of packet transmission is improved when the radio wave state is deteriorating.

Meanwhile, in broadcast-type isochronous transmission, ACKs and the like are not transmitted from the audio playback devices, and thus the present technique for effectively setting the number of retransmissions is particularly useful.

<Example of Configuration of Computer>

The above-described series of processing can also be executed by hardware or software. When the series of processing is executed by software, a program constituting that software is installed, from a program recording medium, in a computer incorporated in dedicated hardware, a general-purpose personal computer, or the like.

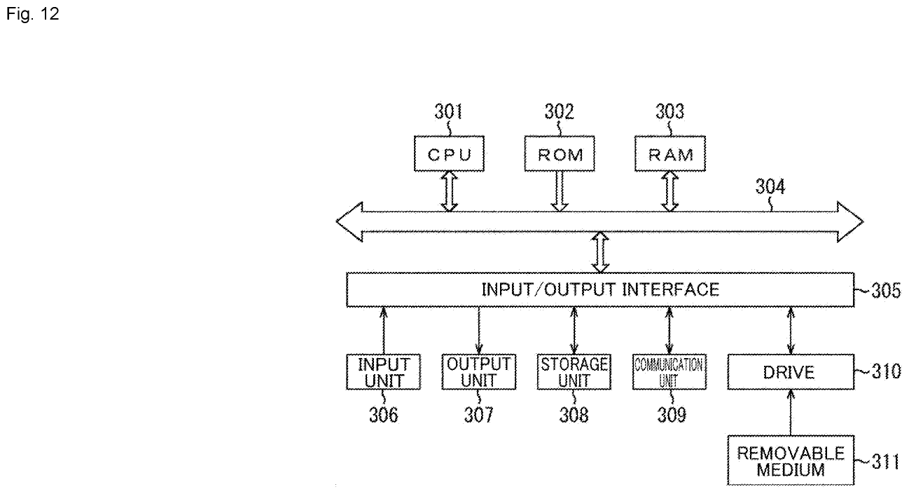

FIG. 12 is a block diagram illustrating an example of the configuration of hardware of a computer that uses a program to execute the above-described series of processing.

A CPU 301, a ROM (Read Only Memory) 302, and a RAM 303 are connected to each other by a bus 304.

An input/output interface 305 is further connected to the bus 304. An input unit 306 constituted by a keyboard, a mouse, and the like and an output unit 307 constituted by a display, a speaker, and the like are connected to the input/output interface 305. In addition, a storage unit 308 constituted by a hard disk, a non-volatile memory, or the like, a communication unit 309 constituted by a network interface or the like, and a drive 310 that drives a removable medium 311 are connected to the input/output interface 305.

In the computer configured as described above, for example, the CPU 301 performs the above-described series of processing by loading a program stored in the storage unit 308 to the RAM 303 via the input/output interface 305 and the bus 304 and executing the program, for example.

For example, the program executed by the CPU 301 is recorded on the removable medium 311 or provided through a wired or wireless transmission medium such as a local area network, the Internet, or a digital broadcast, and is installed in the storage unit 308.

Note that the program executed by the computer may be a program in which the processing is performed chronologically in the order described in the present specification, or may be a program in which the processing is performed in parallel or at a necessary timing such as when called.

Note that, in the present specification, “system” means a set of a plurality of constituent elements (devices, modules (components), or the like), and it does not matter whether or not all the constituent elements are provided in the same housing. Therefore, a plurality of devices contained in separate housings and connected over a network, and one device in which a plurality of modules are contained in one housing, are both “systems”.

Furthermore, the effects described in the present specification are merely exemplary and not intended to be limiting, and other effects may be provided as well.

The embodiments of the present technique are not limited to the above-described embodiments, and various modifications can be made without departing from the essential spirit of the present technique.

For example, the present technique may be configured through cloud computing in which a plurality of devices share and cooperatively process one function over a network. Additionally, the present technique can be applied to data aside from audio data.

In addition, each step described with reference to the foregoing flowcharts can be executed by a single device, or in a distributed manner by a plurality of devices.

Furthermore, when a single step includes a plurality of processes, the plurality of processes included in the single step can be executed by a single device, or in a distributed manner by a plurality of devices.

<Combination Example of Configuration>

The present technique can also be configured as follows.
(1)

A signal processing device including;
a packet generation unit that generates a packet by packetizing encoded data encoded in monaural and separated for channels;
a transmitting unit that transmits, by wireless communication, the packet generated; and
a control unit that controls a number of retransmissions of the packet and a bitrate in accordance with a fluctuation value of a first parameter for estimating a radio wave state, the first parameter being obtained through transmission with a receiving device.
(2)

The signal processing device according to (1),
wherein the control unit performs control to increase the number of retransmissions and reduce the bitrate when the fluctuation value of the first parameter is in an increasing trend, and performs control to reduce the number of retransmissions and increase the bitrate when the fluctuation value of the first parameter is in a decreasing trend.
(3)

The signal processing device according to (2), wherein when the fluctuation value of the first parameter does not change, the control unit does not change the number of retransmissions and the bitrate.
(4)

The signal processing device according to (2), further including:
a storage unit that stores the fluctuation value of the first parameter during packet loss as reference data,
wherein the control unit performs control to increase the number of retransmissions and reduce the bitrate when the fluctuation value of the first parameter is in an increasing trend compared to the reference data, and performs control to reduce the number of retransmissions and increase the bitrate when the fluctuation value of the first parameter is in a decreasing trend compared to the reference data.
(5)

The signal processing device according to (4),
wherein when the fluctuation value of the first parameter does not change compared to the reference data, the control unit performs control such that the number of retransmissions is not changed and the bitrate is not changed.
(6)

The signal processing device according to any one of (1) to (5),
wherein the control unit controls the number of retransmissions and the bitrate based on a variance value of the first parameter and a linear approximation slope.
(7)

The signal processing device according to (6),
wherein the first parameter is an RSSI value.
(8)

The signal processing device according to any one of (1) to (7),
wherein the control unit sets an initial value of the number of retransmissions based on a distance between the receiving device and the signal processing device itself.
(9)

The signal processing device according to (8),
wherein when a plurality of receiving devices are present, the control unit sets the initial value of the number of retransmissions based on a distance between the receiving device located farthest from the signal processing device itself and the signal processing device itself.
(10)

The signal processing device according to (8), further including:
a receiving unit that receives, from the receiving device, a second parameter that is different from the first parameter,
wherein the control unit estimates a distance between the receiving device and the signal processing device itself based on the first parameter and the second parameter.
(11)

The signal processing device according to (10),
wherein the second parameter is a TX power.
(12)

The signal processing device according to (8),
wherein when the receiving device has moved, the control unit resets the initial value of the number of retransmissions.
(13)

The signal processing device according to any one of (1) to (12),
wherein the control unit controls the number of retransmissions and the bitrate without pausing the wireless communication.
(14)

The signal processing device according to any one of (1) to (13),
wherein the encoded data is audio data.
(15)

The signal processing device according to any one of (1) to (14),
wherein a method of the wireless communication is an isochronous method.
(16)

The signal processing device according to (15),
wherein the method of the wireless communication is a broadcast type of the isochronous method.
(17)

A signal processing method performed by a signal processing device, the signal processing method including:
generating a packet by packetizing encoded data encoded in monaural and separated for channels;
transmitting, by wireless communication, the packet generated; and
controlling a number of retransmissions of the packet and a bitrate in accordance with a fluctuation value of a first parameter for estimating a radio wave state, the first parameter being obtained through transmission with a receiving device.
(18)

A learning device including:
a learning unit that learns packet loss occurrence prediction by taking, as inputs, a first parameter that is a parameter for estimating a radio wave state for transmitting, through wireless communication, a packet generated by packetizing encoded data encoded in monaural and separated for channels, and is a parameter obtained through transmission with a receiving device of the packet, a number of retransmissions of the packet, and a second parameter that is a parameter transmitted from the receiving device and is different from the first parameter; and a setting unit that sets a new number of retransmissions of the packet in accordance with the occurrence prediction.
(19)

A learning method performed by a learning device, the learning method including: learning packet loss occurrence prediction by taking, as inputs, a first parameter that is a parameter for estimating a radio wave state for transmitting, through wireless communication, a packet generated by packetizing encoded data encoded in monaural and separated for channels, and is a parameter obtained through transmission with a receiving device of the packet, a number of retransmissions of the packet, and a second parameter that is a parameter transmitted from the receiving device and is different from the first parameter; and setting a new number of retransmissions of the packet in accordance with the occurrence prediction.
(20)

A learning device including:
a learning unit that, by taking a first parameter that is a parameter for estimating a radio wave state for transmitting, through wireless communication, a packet generated by packetizing encoded data encoded in monaural and separated for channels, and is a parameter obtained through transmission with a receiving device of the packet, a number of retransmissions of the packet, and a second parameter that is a parameter transmitted from the receiving device and is different from the first parameter as inputs, learns a new number of retransmissions of the packet.
(21)

A learning method performed by a learning device, the learning method including:
learning, by taking a first parameter that is a parameter for estimating a radio wave state for transmitting, through wireless communication, a packet generated by packetizing encoded data encoded in monaural and separated for channels, and is a parameter obtained through transmission with a receiving device of the packet, a number of retransmissions of the packet, and a second parameter that is a parameter transmitted from the receiving device and is different from the first parameter as inputs, a new number of retransmissions of the packet.
(22)

A signal processing device including:
a receiving unit that, based on a number of retransmissions of a packet and a bitrate controlled in accordance with a fluctuation value of a first parameter obtained through transmission with the signal processing device itself and being used to estimate a radio wave state, receives the packet, the packet being encoded in monaural and separated for channels and transmitted from a transmitting device; and
a decoding unit that decodes the packet.
(23)

A signal processing method performed by a signal processing device, the signal processing method including:
based on a number of retransmissions of a packet and a bitrate controlled in accordance with a fluctuation value of a first parameter obtained through transmission with the signal processing device itself and being used to estimate a radio wave state, receiving the packet, the packet being encoded in monaural and separated for channels and transmitted from a transmitting device; and decoding the packet.
(24)

A signal processing system including:
a first signal processing device having:
a packet generation unit that generates a packet by packetizing encoded data encoded in monaural and separated for channels;
a transmitting unit that transmits, by wireless communication, the packet generated; and
a control unit that controls a number of retransmissions of the packet and a bitrate in accordance with a fluctuation value of a first parameter for estimating a radio wave state, the first parameter being obtained through transmission with a receiving device, and
a second signal processing device having:
a receiving unit that receives the packet transmitted from the first signal processing device; and
a decoding unit that decodes the packet.

### REFERENCE SIGNS LIST

11 Audio playback system
21 Audio server
22, 22-1 to 22-3 Audio playback device
31 Encoding processing unit
32 Packet generation unit
33 Wireless transmission unit
34 Wireless control unit
35 Packet loss determination unit
41, 41-1 to 41-3 Wireless transmission unit
42, 42-1 to 42-3 Packet buffer
43, 43-1 to 43-3 Signal processing unit
44, 44-1 to 44-3 PCM buffer
45-1 to 45-3 DA conversion unit
100 Audio playback system
101 Audio server
102, 102-1 to 102-3 Audio playback device
111 Wireless control unit
112 Packet loss determination unit
121, 121-1 to 121-3 Wireless control unit
151 Packet loss occurrence learning device
160 RF unit
161 Controller
162 Learning engine
163 Retransmission number determination unit
181 Retransmission number learning device
191 Learning engine
200 Audio playback system

1. A signal processing device comprising:
a packet generation unit that generates a packet by packetizing encoded data encoded in monaural and separated for channels;
a transmitting unit that transmits, by wireless communication, the packet generated; and
a control unit that controls a number of retransmissions of the packet and a bitrate in accordance with a fluctuation value of a first parameter for estimating a radio wave state, the first parameter being obtained through transmission with a receiving device.

2. The signal processing device according to claim 1,
wherein the control unit performs control to increase the number of retransmissions and reduce the bitrate when the fluctuation value of the first parameter is in an increasing trend, and performs control to reduce the number of retransmissions and increase the bitrate when the fluctuation value of the first parameter is in a decreasing trend.

3. The signal processing device according to claim 2,
wherein when the fluctuation value of the first parameter does not change, the control unit does not change the number of retransmissions and the bitrate.

4. The signal processing device according to claim 2, further comprising:
a storage unit that stores the fluctuation value of the first parameter during packet loss as reference data,
wherein the control unit performs control to increase the number of retransmissions and reduce the bitrate when the fluctuation value of the first parameter is in an increasing trend compared to the reference data, and performs control to reduce the number of retransmissions and increase the bitrate when the fluctuation value of the first parameter is in a decreasing trend compared to the reference data.

5. The signal processing device according to claim 4,
wherein when the fluctuation value of the first parameter does not change compared to the reference data, the control unit performs control such that the number of retransmissions is not changed and the bitrate is not changed.

6. The signal processing device according to claim 1,
wherein the control unit controls the number of retransmissions and the bitrate based on a variance value of the first parameter and a linear approximation slope.

7. The signal processing device according to claim 6,
wherein the first parameter is an RSSI value.

8. The signal processing device according to claim 1,
wherein the control unit sets an initial value of the number of retransmissions based on a distance between the receiving device and the signal processing device itself.

9. The signal processing device according to claim 8,
wherein when a plurality of receiving devices are present, the control unit sets the initial value of the number of retransmissions based on a distance between the receiving device located farthest from the signal processing device itself and the signal processing device itself.

10. The signal processing device according to claim 8, further comprising:
a receiving unit that receives, from the receiving device, a second parameter that is different from the first parameter,
wherein the control unit estimates a distance between the receiving device and the signal processing device itself based on the first parameter and the second parameter.

11. The signal processing device according to claim 10,
wherein the second parameter is a TX power.

12. The signal processing device according to claim 8,
wherein when the receiving device has moved, the control unit resets the initial value of the number of retransmissions.

13. The signal processing device according to claim 1,
wherein the control unit controls the number of retransmissions and the bitrate without pausing the wireless communication.

14. The signal processing device according to claim 1,
wherein the encoded data is audio data.

15. The signal processing device according to claim 1,
wherein a method of the wireless communication is an isochronous method.

16. The signal processing device according to claim 15,
wherein the method of the wireless communication is a broadcast type of the isochronous method.

17. A learning device comprising:
a learning unit that learns packet loss occurrence prediction by taking, as inputs, a first parameter that is a parameter for estimating a radio wave state for transmitting, through wireless communication, a packet generated by packetizing encoded data encoded in monaural and separated for channels, and is a parameter obtained through transmission with a receiving device of the packet, a number of retransmissions of the packet, and a second parameter that is a parameter transmitted from the receiving device and is different from the first parameter; and
a setting unit that sets a new number of retransmissions of the packet in accordance with the occurrence prediction.

18. A learning device comprising:
a learning unit that, by taking a first parameter that is a parameter for estimating a radio wave state for transmitting, through wireless communication, a packet generated by packetizing encoded data encoded in monaural and separated for channels, and is a parameter obtained through transmission with a receiving device of the packet, a number of retransmissions of the packet, and a second parameter that is a parameter transmitted from the receiving device and is different from the first parameter as inputs, learns a new number of retransmissions of the packet.

19. A signal processing device comprising:
A receiving unit that, based on a number of retransmissions of a packet and a bitrate controlled in accordance with a fluctuation value of a first parameter obtained through transmission with the signal processing device itself and being used to estimate a radio wave state, receives the packet, the packet being encoded in monaural and separated for channels and transmitted from a transmitting device; and
a decoding unit that decodes the packet.
